(19) United States
(12) Patent Application Publication
(10) Pub. No.: US 2026/0308362 A1
(43) Pub. Date: Oct. 8, 2026

(54) METHOD FOR MAKING A MOLDED ARTICLE

(71) Applicant: Milliken & Company, Spartanburg, SC (US)

(72) Inventors: Chi-Chun Tsai, Greer, SC (US); Darin L. Dotson, Moore, SC (US); Keith Alan Keller, Spartanburg, SC (US)

(21) Appl. No.: 19/635,933

(22) Filed: Apr. 1, 2026

Related U.S. Application Data
(60) Provisional application No. 63/783,575, filed on Apr. 4, 2025.

(51) Int. Cl. C08K 13/02; B29C 45/00; B29C 45/27; B29K 23/00; B29K 105/00; B29K 507/04; B29K 509/00; C08J 3/20; C08K 3/04; C08K 3/26; C08K 3/34; C08K 5/098

(52) U.S. Cl. CPC C08K 13/02; B29C 45/0001; B29C 45/2701; C08J 3/201; B29K 2023/12; B29K 2105/0032; B29K 2105/0094; B29K 2507/04; B29K 2509/00; C08J 2323/12; C08J 2323/30; C08K 3/04; C08K 2003/267; C08K 2003/343; C08K 5/098; C08K 2201/014

(57) ABSTRACT

A method of making a molded article comprises the steps of (a) melt mixing a mixture to produce a molten polymer composition, (b) injecting the molten polymer composition into a mold for an article, (c) allowing the molten polymer composition to cool until the molten polymer composition has solidified and formed the molded article; and (d) removing the molded article from the mold.

### TECHNICAL FIELD OF THE INVENTION

The present application relates to methods for making molded articles, such as by injection molding.

### BACKGROUND OF THE INVENTION

Polyolefins are a group of polymer resins that are particularly versatile. Polyolefins are semicrystalline polymers. A polyolefin which has been allowed to cool relatively slowly (e.g., such as the cooling that takes place during the production of molded plastic parts) contains amorphous regions in which the polymer chains are randomly arranged and crystalline regions in which the polymer chains have assumed an orderly configuration. Within these crystalline regions of the polyolefin, the polymer chains align into domains commonly referred to as “crystalline lamellae.” Under normal processing conditions, the crystalline lamellae grow radially in all directions as the polyolefin polymer cools from the molten state. This radial growth results in the formation of spherulites, which are spherical semicrystalline regions composed of multiple crystalline lamellae interrupted by amorphous regions. The size of the spherulites is affected by several parameters and can range from hundreds of nanometers to millimeters in diameter. When the spherulite size is appreciably larger than the wavelength of visible light, the spherulites will scatter visible light passing through the polymer. This scattering of visible light results in a hazy appearance which is commonly referred to as “polymer haze” or simply “haze.” While appreciable levels of polymer haze may be acceptable in some applications, there are certain applications (e.g., storage containers) in which consumers desire relatively transparent plastics and therefore require correspondingly low haze levels.

Several nucleating agents for thermoplastic polymers are known in the art. These nucleating agents generally function by forming nuclei or providing sites for the formation and/or growth of crystals in the thermoplastic polymer as it solidifies from a molten state. The nuclei or sites provided by the nucleating agent allow the crystals to form within the cooling polymer at a higher temperature and/or at a more rapid rate than the crystals will form in the virgin, non-nucleated thermoplastic polymer. These effects can then permit processing of a nucleated thermoplastic polymer composition at cycle times that are shorter than the virgin, non-nucleated thermoplastic polymer.

Some nucleating agents are able to reduce the spherulite size of certain polymers (e.g., polypropylene) to such an extent that the polymer haze is appreciably and noticeably reduced (i.e., the scattering of visible light passing though the polymer is reduced). Such nucleating agents are very beneficial because they enable the polymer to be used in applications where lower haze levels are required or at least desired. In addition to such improvements in optical properties, a desirable nucleating agent can improve other physical properties of the polymer, such as the stiffness or impact resistance. Such improvements again broaden the number of applications or end uses for which the nucleated polymer is suited. And while many nucleating agents can provide one of these physical property improvements, relatively few nucleating agents can provide a desirable combination of two or more physical property enhancements. Further, certain methods of making articles from thermoplastic polymers can be especially challenging. For example, it can be difficult to make via thin wall injection molding articles having acceptable optical properties (e.g., low haze) and sufficient stiffness (e.g., top load).

In view of the above, a need therefore remains for nucleating agents for thermoplastic polymers (e.g., polypropylene), polymer compositions containing such nucleating agents, and methods for molding articles from such polymer compositions that provide a desirable combination of, for example, low haze and high stiffness. The additive compositions, polymer compositions, and molding methods described herein are intended to address such need.

### BRIEF SUMMARY OF THE INVENTION

In a first embodiment, the invention provides a method of making a molded article comprising the steps of (a) melt mixing a mixture to produce a molten polymer composition, (b) injecting the molten polymer composition into a mold for an article, (c) allowing the molten polymer composition to cool until the molten polymer composition has solidified and formed the molded article; and (d) removing the molded article from the mold.

### BRIEF DESCRIPTION OF THE DRAWINGS

FIG. 1 is a cross-sectional, plan view of a mold for an article.

### DETAILED DESCRIPTION OF THE INVENTION

In a first embodiment, the invention provides a method of making a molded article comprising the steps of (a) melt mixing a mixture to produce a molten polymer composition, (b) injecting the molten polymer composition into a mold for an article, (c) allowing the molten polymer composition to cool until the molten polymer composition has solidified and formed the molded article; and (d) removing the molded article from the mold.

In a first step, the method entails melt mixing a mixture to produce a molten polymer composition. The mixture used to produce the molten polymer composition preferably comprises a polypropylene polymer, a calcium salt of rel-(1R,2S)-cyclohexane-1,2-dicarboxylic acid, a zinc salt of a saturated C₁₄-C₂₀ alkyl carboxylic acid, and a layered double hydroxide mineral.

The mixture can comprise any suitable polypropylene polymer. In a preferred embodiment, the polypropylene polymer is selected from the group consisting of polypropylene homopolymers (e.g., atactic polypropylene homopolymer, isotactic polypropylene homopolymer, and syndiotactic polypropylene homopolymer), polypropylene copolymers (e.g., polypropylene random copolymers), polypropylene impact copolymers, and mixtures thereof. Suitable polypropylene copolymers include, but are not limited to, random copolymers made from the polymerization of propylene in the presence of a comonomer selected from the group consisting of ethylene, but-1-ene (i.e., 1-butene), and hex-1-ene (i.e., 1-hexene), with ethylene being particularly preferred. In such polypropylene random copolymers, the comonomer can be present in any suitable amount, but typically is present in an amount of less than about 10 wt. % (e.g., about 0.5 wt. % to about 10 wt. %, or about 1 wt. % to about 7 wt. %). Suitable polypropylene impact copolymers include, but are not limited to, those produced by the addition of a copolymer selected from the group consisting of ethylene-propylene rubber (EPR), ethylenepropylene-diene monomer (EPDM), polyethylene, and plastomers to a polypropylene homopolymer or polypropylene random copolymer. In such polypropylene impact copolymers, the copolymer can be present in any suitable amount, but typically is present in an amount of from about 5 to about 25 wt. %. Suitable polypropylene impact copolymers also include, but are not limited to, copolymers made by the polymerization of propylene and ethylene using one or more Zeigler Natta catalysts. Such polypropylene impact copolymers generally have a heterophasic structure in which an amorphous ethylene-propylene copolymer is dispersed in a semi-crystalline polypropylene homopolymer or copolymer matrix. The polypropylene polymers described above can be branched or cross-linked, such as the branching or cross-linking that results from the addition of additives that increase the melt strength of the polymer. In a preferred embodiment, the polypropylene polymer is a polypropylene homopolymer (e.g., an isotactic polypropylene homopolymer).

The polypropylene polymer can have any suitable melt flow rate. Preferably, the polypropylene polymer has a melt flow rate of 10 g/10 min or more. In another preferred embodiment, the polypropylene polymer has a melt flow rate of about 25 g/10 min or more. In another preferred embodiment, the polypropylene polymer has a melt flow rate of about 50 g/10 min or more. In yet another preferred embodiment, the polypropylene polymer has a melt flow rate of about 60 g/10 min or more. Generally, the melt flow rate of the polypropylene polymer is less than 100 g/10 min. Thus, in a series of preferred embodiments, the polypropylene polymer has a melt flow rate of about 10 g/10 min to about 100 g/10 min, about 25 g/10 min to about 100 g/10 min, about 50 g/10 min to about 100 g/10 min, or about 60 g/10 min to about 100 g/10 min. The melt flow rate of the polypropylene polymer can be measured by any suitable method, such as ASTM D1238 at 230° C. with a 2.16 kg load. Preferably, the melt flow rates of the polypropylene described above are measured in accordance with ASTM D1238 at 230° C. with a 2.16 kg load. Preferably, the polypropylene polymer is not modified with a peroxide or similar vis-breaking agent to yield the melt flow rates described above. Such unmodified polypropylene polymers are generally referred to as “reactor grade” polymers, which name refers to the fact that the polypropylene polymer discharged from the polymerization reactor did not require further modification to achieve the target or reported melt flow rate.

The polypropylene polymer preferably has a relatively low amorphous content and, consequently, relatively high crystallinity. The amorphous content of the polypropylene polymer can be measured by extraction using various solvents and various techniques. The portion of the polypropylene polymer that is extracted by the solvent is referred to as the “soluble fraction,” and the amount of the soluble fraction correlates to the amorphous content of the polypropylene polymer. Preferably, the polypropylene polymer has a soluble fraction of about 4 wt. % or less (e.g., 0.01 wt. % to about 4 wt. %). In another preferred embodiment, the polypropylene polymer has a soluble fraction of about 3.5 wt. % or less (e.g., 0.01 wt. % to about 3.5 wt. %) or about 3 wt. % or less (e.g., about 0.01 wt. % to about 3 wt. %). The soluble fraction of the polypropylene polymer, which is expressed as a weight percentage (wt. %) of the polypropylene polymer, preferably is measured using a Crystex® 42 analyzer (from Polymer Char, Valencia, Spain) and 1,2,4-trichlorobenzene stabilized with 300 ppm of pentaerythritol tetrakis(3-(3,5-di-tert-butyl-4-hydroxyphenyl) propionate) as the solvent. The additional parameters preferably used when analyzing the polymer using the Crystex® 42 analyzer are as follows. A 160 mg sample of the polymer is dissolved in 16 mL of the described solvent. The sample volume injected into the analyzer is 0.3 mL. The dissolution temperature is set to 160° C., the crystallization temperature is set to 40° C., and the analysis temperature is set to 165° C. The dissolution time is 90 min, with stirring set to high. The crystallization time is 40 min.

The mixture can contain any suitable calcium salt of rel-(1R,2S)-cyclohexane-1,2-dicarboxylic acid or mixture of such salts. In one embodiment, the calcium salt of rel-(1R,2S)-cyclohexane-1,2-dicarboxylic acid in the mixture is anhydrous calcium rel-(1R,2S)-cyclohexane-1,2-dicarboxylate. In another embodiment, the calcium salt of rel-(1R,2S)-cyclohexane-1,2-dicarboxylic acid in the mixture is calcium rel-(1R,2S)-cyclohexane-1,2-dicarboxylate monohydrate. In another embodiment, the calcium salt of rel-(1R,2S)-cyclohexane-1,2-dicarboxylic acid in the mixture is a mixture of anhydrous calcium rel-(1R,2S)-cyclohexane-1,2-dicarboxylate and calcium rel-(1R,2S)-cyclohexane-1,2-dicarboxylate monohydrate. In such an embodiment, the anhydrous calcium rel-(1R,2S)-cyclohexane-1,2-dicarboxylate and calcium rel-(1R,2S)-cyclohexane-1,2-dicarboxylate monohydrate can be present in the mixture in any suitable relative amounts. Preferably, the anhydrous calcium rel-(1R,2S)-cyclohexane-1,2-dicarboxylate and calcium rel-(1R,2S)-cyclohexane-1,2-dicarboxylate monohydrate are present in the mixture in a molar ratio (moles of anhydrous calcium rel-(1R,2S)-cyclohexane-1,2-dicarboxylate to moles of calcium rel-(1R,2S)-cyclohexane-1,2-dicarboxylate monohydrate) of about 1:99 to about 99:1, more preferably about 1:19 to about 19:1. In another preferred embodiment, the anhydrous calcium rel-(1R,2S)-cyclohexane-1,2-dicarboxylate and calcium rel-(1R,2S)-cyclohexane-1,2-dicarboxylate monohydrate are present in the mixture in a molar ratio (moles of anhydrous calcium rel-(1R,2S)-cyclohexane-1,2-dicarboxylate to moles of calcium rel-(1R,2S)-cyclohexane-1,2-dicarboxylate monohydrate) of about 3:1 to about 99:1.

The mixture can contain any suitable amount of a calcium salt of rel-(1R,2S)-cyclohexane-1,2-dicarboxylic acid or mixture of such salts. In a preferred embodiment, the mixture contains about 100 ppm or more of the calcium salt of rel-(1R,2S)-cyclohexane-1,2-dicarboxylic acid, based on the total weight of the mixture. In another preferred embodiment, the mixture contains about 150 ppm or more the calcium salt of rel-(1R,2S)-cyclohexane-1,2-dicarboxylic acid, based on the total weight of the mixture. The amount of the calcium salt of rel-(1R,2S)-cyclohexane-1,2-dicarboxylic acid present in the mixture preferably is about 1,000 ppm or less (e.g., about 750 ppm or less or about 500 ppm or less), based on the total weight of the mixture. Thus, in a series of preferred embodiments, the calcium salt of rel-(1R,2S)-cyclohexane-1,2-dicarboxylic acid is present in the mixture in an amount of about 100 ppm to about 1,000 ppm (e.g., about 100 ppm to about 750 ppm or about 100 ppm to about 500 ppm) or about 150 ppm to about 1,000 ppm (e.g., about 150 ppm to about 750 ppm or about 150 ppm to about 500 ppm), based on the total weight of the mixture. If the mixture comprises more than one calcium salt of rel-(1R,2S)-cyclohexane-1,2-dicarboxylic acid, each calcium salt of rel-(1R,2S)-cyclohexane-1,2-dicarboxylic acid can be present in the mixture in one of the amounts recited above, or the combined amount of all calcium salts of rel-(1R,2S)-cyclohexane-1,2-dicarboxylic acid present in the mixture can fall within one of the ranges recited above. Preferably, when the mixture comprises more than one calcium salt of rel-(1R,2S)-cyclohexane-1,2-dicarboxylic acid, the combined amount of all calcium salts of rel-(1R,2S)-cyclohexane-1,2-dicarboxylic acid present in the mixture falls within one of the ranges recited above.

The mixture additionally comprises a zinc salt of a saturated C₁₄-C₂₀ alkyl carboxylic acid. Suitable saturated C₁₄-C₂₀ alkyl carboxylic acids include tetradecanoic acid, hexadecanoic acid, octadecanoic acid, and icosanoic acid. Preferably, the saturated C₁₄-C₂₀ alkyl carboxylic acid is octadecanoic acid, meaning that the zinc salt of a saturated C₁₄-C₂₀ alkyl carboxylic acid preferably comprises zinc octadecanoate. The saturated C₁₄-C₂₀ alkyl carboxylic acids used in making such zinc salts can, in some embodiments, be derived from natural sources that contain a mixture of two or more such acids. Thus, for example, the zinc salt of a saturated C₁₄-C₂₀ alkyl carboxylic acid can be a mixture comprising zinc octadecanoate and zinc hexadecanoate. In such an embodiment, the ratio of these two zinc salts can vary based on the relative abundance of octadecanoic acid and hexadecanoic acid in the acid source used to make the zinc salts. Preferably, when the zinc salt of a saturated C₁₄-C₂₀ alkyl carboxylic acid is a mixture comprising zinc octadecanoate and zinc hexadecanoate, zinc octadecanoate is the predominant zinc salt present in the mixture (i.e., zinc octadecanoate is greater than 50 mol. % of the mixture).

The mixture comprises a layered double hydroxide mineral. The layered double hydroxide mineral preferably is selected from the group consisting of aluminum magnesium hydroxide carbonate, aluminum magnesium zinc hydroxide carbonate, and mixtures thereof. Preferably, the layered double hydroxide mineral has the formula [(Mg²⁺)ₐ (Zn²⁺)_{b}]_{1-c}(Al³⁺)_{c} (OH)₂] (CO₃²⁻)_{c/2}·nH₂O. In the formula for the layered double hydroxide mineral, the value of a is from 0 to 1 (i.e., 0≤a≤1), the value of b is from 0 to 1 (i.e., 0≤b≤1), the sum of a and b is from 0.5 to 1 (i.e., 0.5≤a+b≤1), the value of c is greater than 0 but no greater than 0.5 (i.e., 0<c≤0.5), and the value of n is from 0 to less than 2 (i.e., 0≤n<2). In a preferred embodiment, the layered double hydroxide mineral is an aluminum magnesium hydroxide carbonate having the formula [(Mg²⁺)_{1-c} (Al³⁺)_{c} (OH)₂] (CO₃²⁻)_{c/2}·nH₂O, where the value of c is greater than 0 but no greater than 0.5 (i.e., 0<c≤0.5), and the value of n is from 0 to less than 2 (i.e., 0≤n<2). In another preferred embodiment, the layered double hydroxide mineral is an aluminum magnesium hydroxide carbonate having the formula Mg₆Al₂(CO₃)(OH)₁₆·4H₂O.

In a preferred embodiment, the layered double hydroxide mineral can be at least partially coated with one or more saturated or unsaturated C₁₄-C₂₀ alkyl carboxylic acids (e.g., the layered double hydroxide mineral can be present in the mixture in the form of particles the surfaces of which are at least partially coated with one or more such acids). Suitable saturated or unsaturated C₁₄-C₂₀ alkyl carboxylic acids include, but are not limited to, tetradecanoic acid, hexadecanoic acid, octadecanoic acid, (9Z)-octadec-9-enoic acid, and (9Z,12Z)-octadeca-9,12-dienoic acid. Preferably, the layered double hydroxide mineral is at least partially coated with octadecanoic acid. More preferably, the layered double hydroxide mineral is at least partially coated with a mixture of alkyl carboxylic acids comprising octadecanoic acid and hexadecanoic acid. In another preferred embodiment, the layered double hydroxide mineral is at least partially coated with a mixture of alkyl carboxylic acids comprising octadecanoic acid and (9Z)-octadec-9-enoic acid. In yet another preferred embodiment, the layered double hydroxide mineral is at least partially coated with a mixture of alkyl carboxylic acids comprising octadecanoic acid, (9Z)-octadec-9-enoic acid, and (9Z,12Z)-octadeca-9,12-dienoic acid. When coated with one or more C₁₄-C₂₀ alkyl carboxylic acids as described above, the layered double hydroxide mineral can be coated with up to 5 wt. % of the acid(s) (i.e., the acid(s) account for up to 5 wt. % of the combined mass of the layered double hydroxide mineral and the acid(s) coating the layered double hydroxide mineral), such as from about 0.1 wt. % to 5 wt. %.

The mixture can contain any suitable amount of the layered double hydroxide mineral. In a preferred embodiment, the mixture contains about 100 ppm or more of the layered double hydroxide mineral, based on the total weight of the polymer composition. In another preferred embodiment, the mixture contains about 150 ppm or more of the layered double hydroxide mineral, based on the total weight of the polymer composition. The amount of the layered double hydroxide mineral present in the mixture preferably is about 1,000 ppm or less (e.g., about 750 ppm or less, about 500 ppm or less, or about 400 ppm or less), based on the total weight of the mixture. Thus, in a series of preferred embodiment, the layered double hydroxide mineral is present in the mixture in an amount of about 100 ppm to about 1,000 ppm (e.g., about 100 ppm to about 750 ppm, about 100 ppm to about 500 ppm, or about 100 ppm to about 400 ppm) or about 150 ppm to about 1,000 ppm (e.g., about 150 ppm to about 750 ppm, about 150 ppm to about 500 ppm, or about 150 ppm to about 400 ppm), based on the total weight of the mixture. If the mixture comprises more than one layered double hydroxide mineral, each layered double hydroxide mineral can be present in the mixture in one of the amounts recited above, or the combined amount of all layered double hydroxide minerals present in the mixture can fall within one of the ranges recited above. Preferably, when the mixture comprises more than one layered double hydroxide mineral, the combined amount of all layered double hydroxide minerals present in the mixture falls within one of the ranges recited above.

The calcium salt of rel-(1R,2S)-cyclohexane-1,2-dicarboxylic acid, zinc salt of a saturated C₁₄-C₂₀ alkyl carboxylic acid, and layered double hydroxide mineral can be present in the mixture in any suitable relative amounts. In a preferred embodiment, the ratio of the mass of the zinc salt of a saturated C₁₄-C₂₀ alkyl carboxylic acid present in the mixture to the mass of the calcium salt of rel-(1R,2S)-cyclohexane-1,2-dicarboxylic acid present in the mixture is about 1:3 to about 1:1. More preferably, the ratio of the mass of the zinc salt of a saturated C₁₄-C₂₀ alkyl carboxylic acid present in the mixture to the mass of the calcium salt of rel-(1R,2S)-cyclohexane-1,2-dicarboxylic acid present in the mixture is about 1:2. In another preferred embodiment, the ratio of the mass of the zinc salt of a saturated C₁₄-C₂₀ alkyl carboxylic acid present in the mixture to the mass of the layered double hydroxide mineral present in the mixture is about 1:10 to about 2:1. More preferably, the ratio of the mass of the zinc salt of a saturated C₁₄-C₂₀ alkyl carboxylic acid present in the mixture to the mass of the layered double hydroxide mineral present in the mixture is about 1:10 to about 1:1. In yet another preferred embodiment, the ratio of the mass of the zinc salt of a saturated C₁₄-C₂₀ alkyl carboxylic acid present in the mixture to the mass of the layered double hydroxide mineral present in the mixture is about 1:3 to about 1:1 (e.g., about 2:5 to about 3:4).

In another preferred embodiment, the ratio of the combined total mass of the zinc salt of a saturated C₁₄-C₂₀ alkyl carboxylic acid and the layered double hydroxide mineral present in the mixture to the mass of the calcium salt of rel-(1R,2S)-cyclohexane-1,2-dicarboxylic acid present in the mixture is about 3:4 to about 15:1. More preferably, the ratio of the combined total mass of the zinc salt of a saturated C₁₄-C₂₀ alkyl carboxylic acid and the layered double hydroxide mineral present in the mixture to the mass of the calcium salt of rel-(1R,2S)-cyclohexane-1,2-dicarboxylic acid present in the mixture is about 3:4 to about 2:1. In yet another preferred embodiment, the ratio of the combined total mass of the zinc salt of a saturated C₁₄-C₂₀ alkyl carboxylic acid and the layered double hydroxide mineral present in the mixture to the mass of the calcium salt of rel-(1R,2S)-cyclohexane-1,2-dicarboxylic acid present in the mixture is about 1:1 to about 2:1 (e.g., about 5:4 to about 7:4 or about 5:4 to about 3:2).

In another embodiment, the mixture can comprise one or more pigments in addition to the components described above. In a preferred embodiment, the mixture comprises a pigment selected from the group consisting of blue pigments, violet pigments, black pigments, and mixtures of two or more of the foregoing. Suitable blue pigments include, but are not limited to, C.I. Pigment Blue 29, C.I. Pigment Blue 15, C.I. Pigment Blue 63, and mixtures thereof. Suitable violet pigments include, but are not limited to, C.I. Pigment Violet 15. Suitable black pigments include, but are not limited, carbon black, C.I. Pigment Black 1, C.I. Pigment Black 11, C.I. Pigment Black 31, and mixtures thereof. In a preferred embodiment, the mixture comprises a blue pigment and/or a violet pigment, and the blue pigment and/or violet pigment is a sulfur-containing aluminosilicate. In a preferred embodiment, the mixture comprises a mixture of a blue pigment and a violet pigment, both of which preferably are sulfur-containing aluminosilicate pigments (e.g., a mixture of Pigment Blue 29 and Pigment Violet 15). In another preferred embodiment, the mixture comprises a mixture of a blue pigment and a black pigment, preferably with the blue pigment being a sulfur-containing aluminosilicate pigment (e.g., a mixture of Pigment Blue 29 and carbon black). When present in the mixture, the pigment(s) can account for about 1 wt. % to about 10 wt. % (more preferably about 2 wt. % to about 6 wt. %) of the combined total mass of calcium salt of rel-(1R,2S)-cyclohexane-1,2-dicarboxylic acid, zinc salt of a saturated C₁₄-C₂₀ alkyl carboxylic acid, layered double hydroxide mineral, and pigment(s) present in the mixture.

The mixture used in making the molten polymer composition can contain other nucleating agents in addition to the calcium salt of rel-(1R,2S)-cyclohexane-1,2-dicarboxylic acid described above. Suitable nucleating agents include, but are not limited to, 2,2′-methylene-bis-(4,6-di-tert-butylphenyl) phosphate salts (e.g., sodium 2,2′-methylene-bis-(4,6-di-tert-butylphenyl) phosphate or hydroxyaluminum bis(2,2′-methylene-bis-(4,6-di-tert-butylphenyl) phosphate), bicyclo[2.2.1]heptane-2,3-dicarboxylate salts (e.g., disodium bicyclo[2.2.1]heptane-2,3-dicarboxylate or calcium bicyclo[2.2.1]heptane-2,3-dicarboxylate), cyclohexane-1,2-dicarboxylate salts (e.g., calcium cyclohexane-1,2-dicarboxylate, monobasic aluminum cyclohexane-1,2-dicarboxylate, dilithium cyclohexane-1,2-dicarboxylate, or strontium cyclohexane-1,2-dicarboxylate), glycerolate salts (e.g., zinc glycerolate), phthalate salts (e.g., calcium phthalate), phenylphosphonic acid salts (e.g., calcium phenylphosphonate), and combinations thereof. For the bicyclo[2.2.1]heptane-2,3-dicarboxylate salts and the cyclohexane-1,2-dicarboxylate salts, the carboxylate moieties can be arranged in either the cis- or trans-configuration, with the cis-configuration being preferred. In a preferred embodiment, the mixture further comprises a bicyclo[2.2.1]heptane-2,3-dicarboxylate salt, such as disodium bicyclo[2.2.1]heptane-2,3-dicarboxylate and/or calcium bicyclo[2.2.1]heptane-2,3-dicarboxylate.

In some embodiments, the mixture can also contain a clarifying agent. Suitable clarifying agents include, but are not limited to, trisamides, acetal compounds that are the condensation product of a polyhydric alcohol and an aromatic aldehyde, and triazine derivatives. Suitable trisamide clarifying agents include, but are not limited to, amide derivatives of benzene-1,3,5-tricarboxylic acid, derivatives of N-(3,5-bis-formylamino-phenyl)-formamide (e.g., N-[3,5-bis-(2,2-dimethyl-propionylamino)-phenyl]-2,2-dimethyl-propionamide), derivatives of 2-carbamoyl-malonamide (e.g., N,N′-bis-(2-methyl-cyclohexyl)-2-(2-methyl-cyclohexylcarbamoyl)-malonamide), and combinations thereof. As noted above, the clarifying agent can be an acetal compound that is the condensation product of a polyhydric alcohol and an aromatic aldehyde. Suitable polyhydric alcohols include acyclic polyols such as xylitol and sorbitol, as well as acyclic deoxy polyols (e.g., 1,2,3-trideoxynonitol or 1,2,3-trideoxynon-1-enitol). Suitable aromatic aldehydes typically contain a single aldehyde group with the remaining positions on the aromatic ring being either unsubstituted or substituted. Accordingly, suitable aromatic aldehydes include benzaldehyde and substituted benzaldehydes (e.g., 3,4-dimethyl-benzaldehyde or 4-propyl-benzaldehyde). The acetal compound produced by the aforementioned reaction can be a mono-acetal, di-acetal, or tri-acetal compound (i.e., a compound containing one, two, or three acetal groups, respectively), with the di-acetal compounds being preferred. Suitable acetal-based clarifying agents include, but are not limited to, the clarifying agents disclosed in U.S. Pat. Nos. 5,049,605; 7,157,510; and 7,262,236. Suitable triazine derivative clarifiers include, but are not limited to, the derivatives disclosed in US 2021/0395209, US 2023/0312876, WO 2025/013891 A1. In a preferred embodiment, the triazine derivative clarifying agent is a reaction product of 2,4,6-trichloro-1,3,5-triazine, [1,1′-Biphenyl]-4,4′-diol, and 4-cyclohexylphenol (CAS Reg. No. 2561414-35-3).

The mixture used in making the molten polymer composition can contain other polymer additives in addition to the components described above. Suitable additional polymer additives include, but are not limited to, antioxidants (e.g., phenolic antioxidants, phosphite antioxidants, and combinations thereof), anti-blocking agents (e.g., amorphous silica and diatomaceous earth), pigments (e.g., organic pigments and inorganic pigments) and other colorants (e.g., dyes and polymeric colorants), fillers and reinforcing agents (e.g., glass, glass fibers, talc, calcium carbonate, and magnesium oxysulfate whiskers), nucleating agents, clarifying agents, acid scavengers (e.g., metal salts of fatty acids, such as the metal salts of stearic acid, and hydrotalcite-like materials), polymer processing additives (e.g., fluoropolymer polymer processing additives), polymer cross-linking agents, slip agents (e.g., fatty acid amide compounds derived from the reaction between a fatty acid and ammonia or an amine-containing compound), fatty acid ester compounds (e.g., fatty acid ester compounds derived from the reaction between a fatty acid and a hydroxyl-containing compound, such as glycerol, diglycerol, and combinations thereof), polymer modifiers (e.g., hydrocarbon resin modifiers such as those sold under the Oppera™ tradename by Exxon Mobil Corporation), and combinations of the foregoing.

The mixture used to produce the molten polymer composition can be melt mixed using any suitable apparatus. Preferably, the mixture is melt mixed using a melt extruder, such as a single screw extruder or a twin screw extruder. The mixture is melt mixed at a temperature that is equal to or greater than the melting temperature of the polypropylene polymer present in the mixture. Preferably, the mixture is melt mixed at a temperature of about 180° C. to about 260° C., more preferably about 190° C. to about 240° C. (e.g., about 200° C. to about 230° C.).

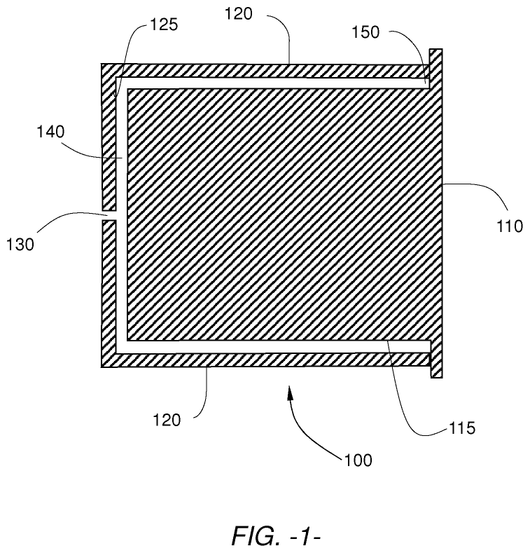

In the second step of the method, the molten polymer composition is injected into a mold for the article. FIG. 1 depicts a cross-sectional plan view of a simple mold suitable for use in the method described herein. The mold 100 comprises a first mold member 110 and a second mold member 120. The first mold member 110 has a first mold surface 115, and the second mold member 120 has a second mold surface 125. When the mold is closed (i.e., when the first mold member 110 and second mold member 120 are mated together as shown in FIG. 1), the first mold surface 115 of the first mold member 110 is opposite the second mold surface 125 of the second mold member 120. Further, the first mold surface 115 of the first mold member 110 and the second mold surface 125 of the second mold member 120 are separated by a distance and enclose a mold cavity 140 defining the article to be molded (not pictured). Depending on the complexity of the mold, the distance between the first mold surface and the second mold surface can vary at different points within the mold cavity. Preferably, the minimum distance at any point within the mold cavity 140 between the first mold surface 115 of the first mold member 110 and the second mold surface 125 of the second mold member 120 is about 3 mm (118 mil) or less (e.g., about 0.25 mm to about 3 mm), about 2 mm (79 mil) or less (e.g., about 0.25 mm to about 2 mm), about 1 mm (39 mil) or less (e.g., about 0.25 mm to about 1 mm), or about 0.75 mm (30 mil) or less (e.g., about 0.25 mm to about 0.75 mm).

The mold 100 additionally comprises a mold inlet 130 (also known as a gate) connected to the mold cavity 140. The molten polymer composition (not pictured) is injected into the mold cavity 140 through the mold inlet 130. The mold cavity 140 provides the path by which the molten polymer composition fills the mold 100 to form the article (not pictured). Thus, the mold 100 has a flow path length that is equal to the distance the molten polymer composition traverses through the mold cavity 140 between the mold inlet 130 and the most distal point 150 of the mold cavity 140 (i.e., the point 150 within the mold cavity 140 that is farthest from the mold inlet 130). The flow path length is the shortest distance between these two points (i.e., the mold inlet 130 and the most distal point 150) through the mold cavity 140. Thus, the beginning point of the flow path length defined by the mold inlet 130 and the most distant point 150 of the mold cavity 140 lie on a common plane passing through both points, such as the plane of the cross section of the mold 100 shown in FIG. 1. Further, the flow path length begins where the mold inlet 130 meets the mold cavity 140-it does not include the length of any sprues and/or runners that may lead to the mold inlet 130.

As can be seen in FIG. 1, the flow path length is much larger than the distance between the first mold surface 115 of the first mold member 110 and the second mold surface 125 of the second mold member 120. Preferably, the flow path length is at least one hundred times greater than the minimum distance between the first mold surface 115 of the first mold member 110 and the second mold surface 125 of the second mold member 120. More preferably, the flow path length is at least about one hundred twenty-five times greater or at least about one hundred fifty times greater than the minimum distance between the first mold surface 115 of the first mold member 110 and the second mold surface 125 of the second mold member 120. Preferably, the flow path length is no more than about five hundred times greater (e.g. no more than about four hundred times greater or no more than about three hundred times greater) than the minimum distance between the first mold surface 115 of the first mold member 110 and the second mold surface 125 of the second mold member 120. Thus, in a series of preferred embodiments, the ratio of the flow path length to the minimum distance between the first mold surface 115 of the first mold member 110 and the second mold surface 125 of the second mold member 120 preferably is 100:1 or more (e.g., 100:1 to about 500:1, 100:1 to about 400:1, or 100:1 to about 300:1), about 125:1 or more (e.g., about 125:1 to about 500:1, about 125:1 to about 400:1, or about 125:1 to about 300:1), or about 150:1 or more (e.g., about 150:1 to about 500:1, about 150:1 to about 400:1, or about 150:1 to about 300:1).

In a third step, the molten polymer composition injected into the mold cavity is allowed to cool until the molten polymer composition has solidified to a sufficient extent to form the molded article. The molten polymer composition can be cooled by any suitable means. For example, the molten polymer composition can be passively cooled by allowing heat to be transferred from the molten polymer composition and mold by radiation, convection, and/or conduction. The molten polymer composition can also be actively cooled by blowing air over the outer surfaces of the mold and/or by passing a coolant (e.g., water) over the mold and/or through passages within one or more of the mold members.

In a fourth step, the molded article is removed from the mold. The molded article is removed by separating the first mold member from the second mold member to open the mold. The article can then be manually removed from either mold member, or the mold (or molding apparatus) can incorporate pins or other elements that push the molded article to eject it from either mold member.

The molded articles produced by the method (and the polymer composition from which they are made) are believed to exhibit a desirable combination of physical properties. For example, the polymer composition produced by melt mixing the mixture described above preferably exhibits a relatively high polymer crystallization temperature. Such polymer composition preferably exhibits a peak polymer recrystallization temperature greater than 120° C. (e.g., about 120° C. to about 130° C.), more preferably about 122° C. or greater (e.g., about 122° C. to about 130° C.). (The peak polymer recrystallization temperature can be determined using differential scanning calorimetry, with the preferred method being described in Example 1 below.). Such polymer composition also exhibits relatively rapid crystallization kinetics, as indicated by a relatively low crystallization half-time. The polymer composition preferably exhibits a crystallization half-time less than 4 minutes (e.g., about 0.5 minutes to 4 minutes, or about 1 minute to 4 minutes), more preferably less than about 3.5 minutes (e.g., about 0.5 minutes to about 3.5 minutes, or about 1 minute to about 3.5 minutes) and even more preferably less than about 3.25 minutes (e.g., about 0.5 minutes to about 3.25 minutes, or about 1 minute to about 3.25 minutes).

Additionally, the articles produced by the method generally exhibit desirably low haze levels. In particular, for an article made from a polypropylene polymer having a melt flow rate of about 50 g/10 min or more (e.g., about 50 g/10 min to about 100 g/10 min), an article/plaque having a thickness of 30 mil (0.762 mm) typically exhibits a haze of less than about 40% (e.g., about 1% to about 40%, about 10% to about 40%, or about 20% to about 40%). In those embodiments in which the polypropylene polymer is a reactor grade polymer having a melt flow rate of about 50 g/10 min or more (e.g., about 50 g/10 min to about 100 g/10 min), an article/plaque having a thickness of 30 mil (0.762 mm) made from the polymer using the described method typically exhibits a haze of less than about 30% (e.g., about 1% to about 30%, about 10% to about 30%, or about 20% to about 30%). (The foregoing haze measurements preferably are determined in accordance with ASTM D1003.)

The articles produced by the described method also generally exhibit desirable levels of stiffness. The stiffness can be measured and quantified by any suitable standard, but preferably the stiffness is determined by measuring the chord modulus in accordance with ISO 178 standard method (and the values reported below preferably are determined in accordance with this method). For example, when measured in the accordance with ISO 178, the polymer composition produced by melt mixing the mixture described above generally exhibits a chord modulus of about 1,450 MPa or more (e.g., about 1,450 MPa to about 3,000 MPa, or about 1,450 MPa to about 2,500 MPa). In those embodiments in which the polypropylene polymer is a reactor grade polymer, the polymer composition produced by melt mixing the mixture described above preferably exhibits a chord modulus of about 1,550 MPa or more (e.g., about 1,550 MPa to about 3,000 MPa, or about 1,550 MPa to about 2,500 MPa). Indeed, some embodiments made utilizing reactor grade polypropylene homopolymers can produce polymer compositions (i.e., the polymer composition produced by melt mixing the mixture described above) exhibiting a chord modulus in excess of 2,000 MPa (e.g., about 2,000 MPa to about 3,000 MPa, or about 2,000 MPa to about 2,500 MPa).

The method described herein can be used to produce any suitable article of manufacture. Suitable articles of manufacture include, but are not limited to, medical devices (e.g., pre-filled syringes for retort applications, intravenous supply containers, and blood collection apparatus), food packaging, liquid containers (e.g., containers for drinks, medications, personal care compositions, shampoos, and the like), apparel cases, microwavable articles, shelving, cabinet doors, mechanical parts, automobile parts, and the like.

The following examples further illustrate the subject matter described above but, of course, should not be construed as in any way limiting the scope thereof.

### Example 1

This example demonstrates the production of thin-wall injection molded parts made in accordance with the method of the invention.

Polymer compositions were prepared by weighing the noted amounts of additives into 3 kg batches of polypropylene homopolymer powder, high intensity mixing the combined ingredients, and extruding the resulting mixture into pellets on a single screw extruder. Table 1 sets forth the amount of each additive contained in each polymer composition. Samples 1A-1J were made with a reactor grade polypropylene homopolymer having an initial melt flow rate of 12 g/10 min (Pro-fax 6301 polypropylene homopolymer from LyondellBasell, designated as “HPP6301” in Table 1). Samples 1F-1J were modified with a peroxide as noted in Table 1 below to have a melt flow rate of approximately 65 g/10 min. Samples 1K-10 were made with polypropylene homopolymer having an initial melt flow rate of 3.7 g/10 min (Pro-fax 6601 polypropylene homopolymer from LyondellBasell) that was modified with a peroxide to yield a melt flow rate of approximately 65 g/10 min (designated as “HPP6601” in Table 1). Samples 1P-1T were made with a reactor grade polypropylene homopolymer having a melt flow rate of 60 g/10 min (“Resin A”). Samples 1U-1Y were made with a reactor grade polypropylene homopolymer having a melt flow rate of 70 g/10 min (“Resin B”). Samples 1Z-1DD were made with a reactor grade polypropylene homopolymer having a melt flow rate of 70 g/10 min (“Resin C”). Samples 1EE-1Il were made with a reactor grade polypropylene homopolymer having a melt flow rate of 80 g/10 min (“Resin D”). In Table 1, “N.A. 1” is anhydrous calcium rel-(1R,2S)-cyclohexane-1,2-dicarboxylate. “ZnOcta” is zinc octadecanoate, and “CaOcta” is calcium octadecanoate. “LDHM 1” is a commercially available aluminum magnesium hydroxide carbonate (DHT-4V™ from Kisuma Chemicals). The peroxide is 2,5-dimethyl-2,5-di(t-butylperoxy) hexane (Varox DBPH from Vanderbilt Chemicals, LLC). Each polymer composition also contained 500 ppm of Irganox® 1010 (BASF) and 1,000 ppm of Irgafos® 168 secondary antioxidant (BASF).

TABLE 1

| | | N.A. 1 | ZnOcta | CaOcta | LDHM 1 | Peroxide |
|---|---|---|---|---|---|---|
| Sample | Resin | (ppm) | (ppm) | (ppm) | (ppm) | (ppm) |
| 1A | HPP6301 | | | 600 | | |
| 1B | HPP6301 | 333 | 167 | 600 | | |
| 1C | HPP6301 | 667 | 333 | 600 | | |
| 1D | HPP6301 | 333 | 167 | | 300 | |
| 1E | HPP6301 | 667 | 333 | | 300 | |
| 1F | HPP6301 | | | 600 | | 455 |
| 1G | HPP6301 | 333 | 167 | 600 | | 455 |
| 1H | HPP6301 | 667 | 333 | 600 | | 455 |
| 1I | HPP6301 | 333 | 167 | | 300 | 455 |
| 1J | HPP6301 | 667 | 333 | | 300 | 455 |
| 1K | HPP6601 | | | 600 | | 1050 |
| 1L | HPP6601 | 333 | 167 | 600 | | 1050 |
| 1M | HPP6601 | 667 | 333 | 600 | | 1050 |
| 1N | HPP6601 | 333 | 167 | | 300 | 1050 |
| 1O | HPP6601 | 667 | 333 | | 300 | 1050 |
| 1P | Resin A | | | 600 | | |
| 1Q | Resin A | 333 | 167 | 600 | | |
| 1R | Resin A | 667 | 333 | 600 | | |
| 1S | Resin A | 333 | 167 | | 300 | |
| 1T | Resin A | 667 | 333 | | 300 | |
| 1U | Resin B | | | 600 | | |
| 1V | Resin B | 333 | 167 | 600 | | |
| 1W | Resin B | 667 | 333 | 600 | | |
| 1X | Resin B | 333 | 167 | | 300 | |
| 1Y | Resin B | 667 | 333 | | 300 | |
| 1Z | Resin C | | | 500 | | |
| 1AA | Resin C | 333 | 167 | 500 | | |
| 1BB | Resin C | 667 | 333 | 500 | | |
| 1CC | Resin C | 333 | 167 | | 300 | |
| 1DD | Resin C | 667 | 333 | | 300 | |
| 1EE | Resin D | | | 600 | | |
| 1FF | Resin D | 333 | 167 | 600 | | |
| 1GG | Resin D | 667 | 333 | 600 | | |
| 1HH | Resin D | 333 | 167 | | 300 | |
| 1II | Resin D | 667 | 333 | | 300 | |

The polymer compositions were compounded on a DeltaPlast single screw extruder. The barrel temperature of the extruder was ramped from 200 to 230° C. and the screw speed was set at approximate 130 rpm. The extruded pellets of each polymer composition were then injection molded into 16 U.S. fluid ounce (470 mL) deli cups on a Husky injection molding machine with all barrels set at 220° C., an injection rate of 140 mm/s, a back pressure of 50 psi (0.14 MPa), and the mold cooling water set at 45° C. The deli cups had a circular base measuring 3.637 inches (92.38 mm) in diameter, a height of 3 inches (76.2 mm), and a circular open at the top having a rim measuring 4.266 inches (108.4 mm) in diameter at the inner edge of the rim and 4.612 inches (117.1 mm) in diameter at the outer edge of the rim. The deli cups had a wall thickness of 26 mil (0.66 mm).

After molding, the deli cups were then tested to determine several physical properties. The compression top load was measured in accordance with ASTM D2659. The haze was measured in accordance with ASTM D1003. The crystallization behavior, specifically the crystallization half-time (t−½) and peak polymer recrystallization temperature (Tc), were measured using differential scanning calorimetry (Mettler-Toledo DSC822 differential scanning calorimeter). The peak polymer crystallization temperature (T_{c}) was determined by heating an approximately 5 milligram sample at 20° C./minute from 50° C. to 220° C., holding temperature at 220° C. for 2 minutes to remove any thermal history, and cooling the sample at a rate of 20° C./minute down to 50° C. The peak of the crystallization exotherm was recorded as peak polymer recrystallization temperature (Tc). The crystallization half-time was measured at 140° C.

The soluble fraction of each polymer was measured using a Crystex® 42 analyzer (Polymer Char, Valencia, Spain) and 1,2,4-trichlorobenzene stabilized with 300 ppm of pentaerythritol tetrakis(3-(3,5-di-tert-butyl-4-hydroxyphenyl) propionate). A 160 mg sample of the polymer was dissolved in 16 mL of solvent. The sample volume injected into the analyzer was 0.3 mL. The dissolution temperature was 160° C., the crystallization temperature was 40° C., and the analysis temperature was 165° C. The dissolution time was 90 min, with stirring set to high. The crystallization time was 40 min.

The results of these measurements are set forth in Table 2 below.

TABLE 2

| | Soluble | MFR | | | | |
|---|---|---|---|---|---|---|
| | Fraction | (g/10 | t-½ | T_{c} | Top | |
| Sample | (wt. %) | min) | (mins) | (° C.) | Load (N) | Haze (%) |
| 1A | 4.43 | 12 | 8.76 | 119.3 | 1119.4 | 33.2 |
| 1B | 4.43 | 12 | 4.41 | 123.3 | 1287.8 | 18.7 |
| 1C | 4.43 | 12 | 3.73 | 123.8 | 1337.2 | 16.6 |
| 1D | 4.43 | 12 | 3.05 | 124.8 | 1304.4 | 16.8 |
| 1E | 4.43 | 12 | 2.48 | 125.2 | 1339.2 | 16.3 |
| 1F | 5.61 | 65 | 7.03 | 121.0 | 1016.7 | 45.3 |
| 1G | 5.61 | 65 | 3.28 | 125.5 | 1142.7 | 28.9 |
| 1H | 5.61 | 65 | 2.69 | 126.0 | 1141.6 | 26.7 |
| 1I | 5.61 | 65 | 2.58 | 126.0 | 1154.8 | 23.6 |
| 1J | 5.61 | 65 | 2.37 | 126.8 | 1146.7 | 20.6 |
| 1K | 4.69 | 70 | 8.97 | 119.5 | 986.6 | 37.1 |
| 1L | 4.69 | 70 | 3.98 | 124.2 | 1161.7 | 28.5 |
| 1M | 4.69 | 70 | 3.31 | 124.8 | 1267.0 | 24 |
| 1N | 4.69 | 70 | 3.01 | 125.2 | 1170.6 | 27.1 |
| 1O | 4.69 | 70 | 2.88 | 125.5 | 1257.0 | 25.1 |
| 1P | 3.88 | 60 | 14.48 | 118.8 | 1187.4 | 45.5 |
| 1Q | 3.88 | 60 | 4.69 | 123.8 | 1203.8 | 33.5 |
| 1R | 3.88 | 60 | 3.80 | 124.2 | 1468.5 | 32.9 |
| 1S | 3.88 | 60 | 2.58 | 126.2 | 1347.4 | 25.9 |
| 1T | 3.88 | 60 | 2.23 | 126.7 | 1458.4 | 22.3 |
| 1U | 2.89 | 70 | 9.15 | 121.2 | 1220.3 | 46.2 |
| 1V | 2.89 | 70 | 2.95 | 126.2 | 1539.0 | 33.1 |
| 1W | 2.89 | 70 | 2.15 | 127.3 | 1570.3 | 28.9 |
| 1X | 2.89 | 70 | 1.59 | 128.5 | 1577.4 | 24.9 |
| 1Y | 2.89 | 70 | 1.35 | 129.3 | 1625.4 | 21.1 |
| 1Z | 2.78 | 70 | 14.28 | 118.8 | 1351.0 | 71.3 |
| 1AA | 2.78 | 70 | 6.23 | 123.7 | 1484.1 | 42.4 |
| 1BB | 2.78 | 70 | 4.32 | 125.0 | 1523.9 | 38.4 |
| 1CC | 2.78 | 70 | 2.25 | 126.7 | 1559.3 | 27.0 |
| 1DD | 2.78 | 70 | 1.96 | 127.0 | 1582.7 | 24.5 |
| 1EE | 2.46 | 80 | 11.36 | 123.2 | 1362.5 | 58.8 |
| 1FF | 2.46 | 80 | 2.58 | 125.2 | 1581.6 | 40.9 |
| 1GG | 2.46 | 80 | 2.00 | 127.2 | 1547.3 | 36.3 |
| 1HH | 2.46 | 80 | 1.80 | 127.5 | 1549.5 | 28.2 |
| 1II | 2.46 | 80 | 1.56 | 128.2 | 1597.7 | 19.1 |

As can be seen from the data in Table 2, the polymer compositions containing a calcium salt of rel-(1R,2S)-cyclohexane-1,2-dicarboxylic acid, a zinc salt of a saturated C₁₄-C₂₀ alkyl carboxylic acid (e.g., zinc octadecanoate), and a layered double hydroxide mineral all exhibited improved crystallization half-time, peak polymer recrystallization temperature, top load, and haze relative to the comparable unnucleated resin (having the same melt flow rate) as well as the comparable polymer compositions containing a calcium salt of rel-(1R,2S)-cyclohexane-1,2-dicarboxylic acid, zinc octadecanoate, and calcium octadecanoate. Further, the relative improvements observed for such polymer compositions were greater when the polypropylene homopolymer had a soluble fraction of less 4 wt. %.

### Example 2

This example demonstrates the production of polymer compositions according to the invention and certain physical properties of thin-wall injection molded parts made with such polymer compositions.

Polymer compositions were prepared by weighing the noted amounts of additives into 3 kg batches of polypropylene homopolymer powder, high intensity mixing the combined ingredients, and extruding the resulting mixture into pellets on a single screw extruder. Table 3 sets forth the amount of each additive contained in each polymer composition. All samples were made with a second reactor grade polypropylene homopolymer having a melt flow rate of 70 g/10 min. In Table 3, “N.A. 1” is anhydrous calcium rel-(1R,2S)-cyclohexane-1,2-dicarboxylate, “N.A. 2” is calcium rel-(1R,2S)-cyclohexane-1,2-dicarboxylate monohydrate, and “N.A. 3” is disodium bicyclo[2.2.1]heptane-2,3-dicarboxylate. “N.A. 4” is a hydrotalcite modified with cis-cyclohexane-1,2-dicarboxylic acid as described in International Patent Application Publication No. WO 2024/085755 A1. “ZnOcta” is zinc octadecanoate, and “CaOcta” is calcium octadecanoate. “LDHM 1” is a commercially available aluminum magnesium hydroxide carbonate (DHT-4V™ from Kisuma Chemicals). “Add. 1” is a hydrophobically modified silica (Sylobloc M250 from W.R. Grace Company). Each polymer composition also contained 500 ppm of Irganox® 1010 (BASF) and 1,000 ppm of Irgafos® 168 secondary antioxidant (BASF).

TABLE 3

| | N.A. 1 | N.A. 2 | N.A. 3 | N.A. 4 | ZnOcta | CaOcta | LDHM 1 | Add. 1 |
|---|---|---|---|---|---|---|---|---|
| Sample | (ppm) | (ppm) | (ppm) | (ppm) | (ppm) | (ppm) | (ppm) | (ppm) |
| 2A | | | | | | 500 | | |
| 2B | 350 | | | | | 500 | | |
| 2C | 333 | | | | 167 | 500 | | |
| 2D | 667 | | | | 333 | 500 | | |
| 2E | 333 | | | | 167 | | 300 | |
| 2F | 667 | | | | 333 | | 300 | |
| 2G | | 333 | | | 167 | 500 | | |
| 2H | | 667 | | | 333 | 500 | | |
| 2I | | 333 | | | 167 | | 300 | |
| 2J | | 667 | | | 333 | | 300 | |
| 2K | 192 | | 171 | | 94 | 500 | | 43 |
| 2L | 302 | | 40 | | 148 | 500 | | 10 |
| 2M | 192 | | 171 | | 94 | | 300 | 43 |
| 2N | 302 | | 40 | | 148 | | 300 | 10 |
| 2O | | | | 500 | | | | |
| 2P | | | | 800 | | | | |

The polymer compositions were compounded on a DeltaPlast single screw extruder and injection molded into deli cups as described in Example 1 above. The deli cups were then tested as described in Example 1 above, and the results are reported in Table 4 below.

TABLE 4

| | t-½ | T_{c} | Top Load | Haze |
|---|---|---|---|---|
| Sample | (mins) | (° C.) | (N) | (%) |
| 2A | 14.28 | 118.8 | 1351.0 | 71.3 |
| 2B | 3.92 | 124.8 | 1479.7 | 38.3 |
| 2C | 6.23 | 123.7 | 1484.1 | 42.4 |
| 2D | 4.32 | 125.0 | 1523.9 | 38.4 |
| 2E | 2.25 | 126.7 | 1559.3 | 27.0 |
| 2F | 1.96 | 127.0 | 1582.7 | 24.5 |
| 2G | 5.78 | 122.5 | 1567.3 | 39.9 |
| 2H | 4.16 | 124.0 | 1598.6 | 32.9 |
| 2I | 2.96 | 125.2 | 1682.5 | 27.1 |
| 2J | 3.09 | 125.8 | 1670.6 | 23.7 |
| 2K | 2.25 | 126.8 | 1477.3 | 40.3 |
| 2L | 3.28 | 125.3 | 1534.3 | 35.4 |
| 2M | 1.21 | 129.5 | 1461.4 | 35.1 |
| 2N | 1.74 | 128.2 | 1517.0 | 29.2 |
| 2O | 5.41 | 123.2 | 1390.4 | 50.1 |
| 2P | 12.47 | 122.2 | 1325.0 | 71.4 |

As can be seen from the data in Table 4, the polymer compositions containing a calcium salt of rel-(1R,2S)-cyclohexane-1,2-dicarboxylic acid, a zinc salt of a saturated C₁₄-C₂₀ alkyl carboxylic acid (e.g., zinc octadecanoate), and a layered double hydroxide mineral all exhibited improved crystallization half time, peak polymer recrystallization temperature, top load, and haze relative to the unnucleated resin as well as the comparable polymer compositions containing a calcium salt of rel-(1R,2S)-cyclohexane-1,2-dicarboxylic acid, zinc octadecanoate, and calcium octadecanoate. Further, the polymer compositions containing a calcium salt of rel-(1R,2S)-cyclohexane-1,2-dicarboxylic acid, a zinc salt of a saturated C₁₄-C₂₀ alkyl carboxylic acid (e.g., zinc octadecanoate), and a layered double hydroxide mineral exhibited markedly better properties than the polymer composition containing a hydrotalcite that had been modified with cis-cyclohexane-1,2-dicarboxylic acid (Samples 20 and 2P).

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the subject matter of this application (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter of the application and does not pose a limitation on the scope of the subject matter unless otherwise claimed. No language in the specification should be construed as indicating any non-claimed element as essential to the practice of the subject matter described herein.

Preferred embodiments of the subject matter of this application are described herein, including the best mode known to the inventors for carrying out the claimed subject matter. Variations of those preferred embodiments may become apparent to those of ordinary skill in the art upon reading the foregoing description. The inventors expect skilled artisans to employ such variations as appropriate, and the inventors intend for the subject matter described herein to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the present disclosure unless otherwise indicated herein or otherwise clearly contradicted by context.

1. A method of making a molded article, the method comprising the steps of:
(a) melt mixing a mixture to produce a molten polymer composition, the mixture comprising (i) a polypropylene polymer having a melt flow rate of 50 g/10 min or more, (ii) a calcium salt of rel-(1R,2S)-cyclohexane-1,2-dicarboxylic acid, (iii) a zinc salt of a saturated C₁₄-C₂₀ alkyl carboxylic acid, and (iv) a layered double hydroxide mineral selected from the group consisting of aluminum magnesium hydroxide carbonate, aluminum magnesium zinc hydroxide carbonate, and mixtures thereof;
(b) injecting the molten polymer composition into a mold for an article, wherein (A) the mold comprises a first mold member having a first mold surface and a second mold member having a second mold surface, (B) when the first mold member and second mold member are mated together, the first mold surface of the first mold member and the second mold surface of the second mold member are separated by a distance and enclose a mold cavity defining the article, (C) the mold comprises a mold inlet connected to the mold cavity and through which the molten polymer composition is injected into the mold cavity, (D) the mold has a flow path length equal to a distance traversed through the mold cavity between the mold inlet and a point of the mold cavity that is most distal from the mold inlet, and (E) the ratio of the flow path length to the minimum distance within the mold cavity between the first mold surface of the first mold member and the second mold surface of the second mold member is 100:1 or more;
(c) allowing the molten polymer composition to cool until the molten polymer composition has solidified and formed the molded article; and
(d) removing the molded article from the mold.

2. The method of claim 1, wherein the polypropylene polymer is a polypropylene homopolymer.

3. The method of claim 1, wherein the polypropylene polymer has a melt flow rate of 60 g/10 min or more.

4. The method of claim 1, wherein the calcium salt of rel-(1R,2S)-cyclohexane-1,2-dicarboxylic acid is anhydrous calcium rel-(1R,2S)-cyclohexane-1,2-dicarboxylate.

5. The method of claim 1, wherein the calcium salt of rel-(1R,2S)-cyclohexane-1,2-dicarboxylic acid is calcium rel-(1R,2S)-cyclohexane-1,2-dicarboxylate monohydrate.

6. The method of claim 1, wherein the calcium salt of rel-(1R,2S)-cyclohexane-1,2-dicarboxylic acid is a mixture of anhydrous calcium rel-(1R,2S)-cyclohexane-1,2-dicarboxylate and calcium rel-(1R,2S)-cyclohexane-1,2-dicarboxylate monohydrate.

7. The method of claim 1, wherein the zinc salt of a saturated C₁₄-C₂₀ alkyl carboxylic acid comprises zinc octadecanoate.

8. The method of claim 1, wherein the layered double hydroxide has the formula [(Mg²⁺) a (Zn²⁺)_{b}]_{1-c} (Al³⁺)_{c} (OH)₂] (CO₃²⁻)_{c/2}·nH₂O, where the value of a is from 0 to 1, the value of b is from 0 to 1, the sum of a and b is from 0.5 to 1, the value of c is greater than 0 but no greater than 0.5, and the value of n is from 0 to less than 2.

9. The method of claim 8, wherein the layered double hydroxide mineral is an aluminum magnesium hydroxide carbonate having the formula
[(Mg²⁺)_{1-c} (Al³⁺)_{c} (OH)₂] (CO₃²⁻)_{c/2}·nH₂O, where the value of c is greater than 0 but no greater than 0.5, and the value of n is from 0 to less than 2.

10. The method of claim 1, wherein the ratio of the mass of the zinc salt of a saturated C₁₄-C₂₀ alkyl carboxylic acid present in the mixture to the mass of the calcium salt of rel-(1R,2S)-cyclohexane-1,2-dicarboxylic acid present in the mixture is about 1:3 to about 1:1.

11. The method of claim 1, wherein the ratio of the mass of the zinc salt of a saturated C₁₄-C₂₀ alkyl carboxylic acid present in the mixture to the mass of the layered double hydroxide mineral present in the mixture is about 1:10 to about 2:1.

12. The method of claim 11, wherein the ratio of the mass of the zinc salt of a saturated C₁₄-C₂₀ alkyl carboxylic acid present in the mixture to the mass of the layered double hydroxide mineral present in the mixture is about 1:10 to about 1:1.

13. The method of claim 12, wherein the ratio of the combined total mass of the zinc salt of a saturated C₁₄-C₂₀ alkyl carboxylic acid and the layered double hydroxide mineral present in the mixture to the mass of the calcium salt of rel-(1R,2S)-cyclohexane-1,2-dicarboxylic acid present in the mixture is about 3:4 to about 15:1.

14. The method of claim 13, wherein the ratio of the combined total mass of the zinc salt of a saturated C₁₄-C₂₀ alkyl carboxylic acid and the layered double hydroxide mineral present in the mixture to the mass of the calcium salt of rel-(1R,2S)-cyclohexane-1,2-dicarboxylic acid present in the mixture is about 3:4 to about 2:1.

15. The method of claim 14, wherein the mixture comprises a pigment selected from the group consisting of blue pigments, violet pigments, black pigments, and mixtures of two or more of the foregoing.

16. The method of claim 15, wherein the mixture comprises a blue pigment or a violet pigment, and the blue pigment or violet pigment is a sulfur-containing aluminosilicate.

17. The method of claim 1, wherein the mixture comprises carbon black.

18. The method of claim 1, wherein the calcium salt of rel-(1R,2S)-cyclohexane-1,2-dicarboxylic acid is present in the mixture in an amount of about 100 ppm to about 1,000 ppm, based on the total weight of the mixture.

19. The method of claim 1, wherein the layered double hydroxide mineral is present in the mixture in an amount of about 100 ppm to about 1,000 ppm.

20. The method of claim 1, wherein the mixture further comprises a bicyclo[2.2.1]heptane-2,3-dicarboxylate salt.
